(19) United States
(12) Patent Application Publication
(10) Pub. No.: US 2009/0105411 A1
(43) Pub. Date: Apr. 23, 2009

(54) AQUEOUS NON-IONIC HYDROPHILIC POLYURETHANE DISPERSIONS, AND A CONTINUOUS PROCESS OF MAKING THE SAME

(76) Inventors: Bedri Erdem, Midland, MI (US); Mark R. Adams, Plainfield, IL (US); Robert C. Frye, Woodstock, GA (US); Debkumar Bhattacharjee, Lake Jackson, TX (US); Duane R. Roberts, League City, TX (US)

Correspondence Address: The Dow Chemical Company, Intellectual Property Section, P.O. Box 1967, Midland, MI, 48641-1967, US

(21) Appl. No.: 12/300,520

(22) PCT Filed: May 8, 2007
(86) PCT No.: PCT/US07/68466

§ 371 Date: Nov. 12, 2008

Related U.S. Application Data
(60) Provisional application No. 60/800,793, filed on May 16, 2006.

(51) Int. Cl. C08L 75/04

(52) U.S. Cl. 524/591

(57) ABSTRACT

The instant invention is an aqueous non-ionic hydrophilic polyurethane dispersion, and a continuous process for making the same. The aqueous non-ionic hydrophilic polyurethane dispersion according to instant invention includes the reaction product of a non-ionic hydrophilic prepolymer, water, optionally an external surfactant, and optionally a chain-extending reagent. The non-ionic hydrophilic prepolymer includes the reaction product of a first component and a second component. The first component is selected from the group consisting of an aromatic polyisocyanate, an aliphatic polyisocyanate, and combinations thereof. The second component is a hydrophilic alkylene oxide polyol, a non-ionic hydrophilic alkylene oxide monol, or combinations thereof. The continuous process for producing the non-ionic hydrophilic aqueous polyurethane dispersion includes the following steps: (1) providing a disperse phase liquid stream having a flow rate R₂, wherein the disperse phase liquid stream contains a non-ionic hydrophilic polyurethane prepolymer comprising the reaction product of (a) a first component, wherein the first component is an aromatic polyisocyanate, aliphatic polyisocyanate, or combinations thereof; and (b) a second component, wherein the second component is a non-ionic hydrophilic alkylene oxide polyol, a non-ionic hydrophilic alkylene oxide monol, or combinations thereof; (2) providing a continuous phase liquid stream having a flow rate R₁, wherein the continuous phase liquid stream comprising water and optionally a surfactant; (3) continuously merging the disperse phase liquid stream and the continuous phase liquid stream into a high-shear disperser, wherein R₂:R₁ is in the range of 10:90 to 30:70; (4) emulsifying the non-ionic hydrophilic polyurethane prepolymer in the water via a high-shear disperser; and (5) thereby producing the non-ionic hydrophilic aqueous polyurethane dispersion.

### CROSS-REFERENCE TO RELATED APPLICATIONS

This application is a non-provisional application claiming priority from the U.S. Provisional Patent Application Ser. No. 60/800,793, filed on May 16, 2006 entitled “AQUEOUS NON-IONIC HYDROPHILIC POLYURETHANE DISPERSIONS, AND A CONTINUOUS PROCESS OF MAKING THE SAME,” the teachings of which are incorporated herein as if reproduced in full hereinbelow.

### FIELD OF INVENTION

The instant invention relates to an aqueous non-ionic hydroplilic polyurethane dispersion, and a continuous process for making the same.

### BACKGROUND OF THE INVENTION

Aqueous polyurethane dispersions are generally well known and are used in the production of useful polyurethane products. Different techniques have been employed to facilitate the production of aqueous polyurethane dispersions.

U.S. Pat. No. 6,897,281 describes a breathable polyurethane having an upright moisture vapor transmission rate of more than about 500 gms/m²/24 hr. The breathable polyurethane includes: (a) poly(alkylene oxide) side-chain units in an amount comprising 12 weight percent to 80 weight percent of the polyurethane, wherein (i) alkylene oxide groups in the poly(alkylene oxide) side-chain units have from 2 to 10 carbon atoms and are unsubstituted, substituted, or both unsubstituted and substituted, (ii) at least about 50 weight percent of the alkylene oxide groups are ethylene oxide, and (iii) the amount of the side-chain units is at least about 30 weight percent when the molecular weight of the side-chain units is less than about 600 grams/mole, at least about 15 weight percent when the molecular weight of the side-chain units is from 600 to 1,000 grams/mole, and at least about 12 weight percent when the molecular weight of the side-chain units is more than about 1,000 grams/mole, and (b) poly(ethylene oxide) main-chain units in an amount including less than about 25 weight percent of the polyurethane.

U.S. Pat. No. 5,700,867 describes an aqueous dispersion of an aqueous polyurethane having an ionic functional group, polyoxyethylene units, and terminal hydrazine functional groups. Content of the ionic functional group is 5 to 180 milliequivalent per 100 g of the aqueous polyurethane, and content of the polyoxyethylene unit is about 20 percent by weight or less of a weight of the aqueous polyurethane.

U.S. Pat. No. 5,043,381 describes an aqueous dispersion of a non-ionic water-dispersible polyurethane having pendent polyoxyethylene chains, and one crosslink per 3,000 to 100,000 atomic weight units.

U.S. Pat. No. 4,092,286 describes water-dispersible polyurethane elastomers having a substantially linear molecular structure characterized by (a) lateral polyalkylene oxide polyether chains having a content of ethylene oxide units of from about 0.5 to 10 percent by weight, based on the polyurethane as a whole and (b) a content of ionic groups of from about 0.1 to 15 milliequivalents per 100 g.

U.S. Pat. No. 3,920,598 describes a polyurethane, which is adapted to be dispersed in water without an emulsifier. The polyurethane, adapted to be dispersed in water without an emulsifier, is prepared by reacting an organic compound having reactive hydrogen atoms determinable by the Zerewitinoff method with an organic diisocyanate having a side chain which contains repeating (—O—CH₂—CH₂) groups.

Japanese Patent Disclosure No. 57-39212 describes a method of molding polyurethanes in which an aqueous emulsion of polyurethane with a specific structure is solidified via heat treatment. The aqueous emulsion of polyurethane is the product of a prepolymer obtained by reacting (a) polyisocyanate; (b) polyoxyethylene glycol compounds with molecular weights of 800-1500, at 6-30 weight percent; and (c) polyhydroxyl compounds other than (ii).

Despite the research efforts in developing and improving aqueous polyurethane dispersions, there is still a need for further improved aqueous polyurethane dispersions, and method of making thereof.

### SUMMARY OF THE INVENTION

The instant invention is an aqueous non-ionic hydrophilic polyurethane dispersion, and a continuous process for making the same. The aqueous non-ionic hydrophilic polyurethane dispersion according to instant invention includes the reaction product of a non-ionic hydrophilic prepolymer, water, optionally an external surfactant, and optionally a chain-extending reagent. The non-ionic hydrophilic prepolymer includes the reaction product of a first component and a second component. The first component is selected from the group consisting of an aromatic polyisocyanate, an aliphatic polyisocyanate, and combinations thereof. The second component is a hydrophilic alkylene oxide polyol, a non-ionic hydrophilic alkylene oxide monol, or combinations thereof. The continuous process for producing the non-ionic hydrophilic aqueous polyurethane dispersion includes the following steps: (1) providing a disperse phase liquid stream having a flow rate R₂, wherein the disperse phase liquid stream contains a non-ionic hydrophilic polyurethane prepolymer comprising the reaction product of (a) a first component, wherein the first component is an aromatic polyisocyanate, aliphatic polyisocyanate, or combinations thereof; and (b) a second component, wherein the second component is a non-ionic hydrophilic alkylene oxide polyol, a non-ionic hydrophilic alkylene oxide monol, or combinations thereof; (2) providing a continuous phase liquid stream having a flow rate R₁, wherein the continuous phase liquid stream comprising water and optionally a surfactant; (3) continuously merging the disperse phase liquid stream and the continuous phase liquid stream into a high-shear disperser, wherein R₂:R₁ is in the range of 10.90 to 30:70; (4) emulsifying the non-ionic hydrophilic polyurethane prepolymer in the water via a high-shear disperser; and (5) thereby producing the non-ionic hydrophilic aqueous polyurethane dispersion.

### DETAILED DESCRIPTION OF THE INVENTION

The aqueous non-ionic hydrophilic polyurethane dispersion according to instant invention includes the reaction product of a non-ionic hydrophilic prepolymer, water, optionally an external surfactant, and optionally a chain-extending reagent. The non-ionic hydrophilic prepolymer includes the reaction product of a first component and a second component. The first component is selected from the group consisting of an aromatic polyisocyanate, an aliphatic polyisocyanate, and combinations thereof. The second component is a hydrophilic alkylene oxide polyol, a non-ionic hydrophilic alkylene oxide monol, or combinations thereof.

The first component may be any known aromatic polyisocyanate, aliphatic polyisocyanate, or combinations thereof. These polyisocyanates include those containing at least about two isocyanate groups per molecule, preferably, those containing an average of from 2.0 to 3.0 isocyanate groups per molecule. The polyisocyanates may preferably be aromatic polyisocyanate, aliphatic polyisocyanate, or combinations thereof. Exemplary polyisocynates include, but are not limited to, toluene diisocyanates (TDI), diphenylmethane-4,4′-diisocyanate (MDI), xylylene diisocyanate, naphthalene-1,5-diisocyanate, p-phenylene diisocyanate, dibenzyl diisocyanate, diphenyl ether diisocyanate, m- or p-tetramethylxylylene diisocyanate, triphenylmethane triisocyanate. Furthermore, aliphatic diisocyanates (which further encompasses alicyclic diisocyanates) include those disclosed in U.S. Pat. No. 5,494,960, herein, such as hydrogenated tolylene diisocyanate, hydrogenated diphenylmethane-4,4′-diisocyanate (H₁₂MDI), 1,4-tetramethylene diisocyanate, hexamethylene diisocyanate (HDI), hydrogenated xylylene diisocyanate, cyclohexyl-1,4-diisocyanate, and isophorone diisocyanate (IPDI) as well as 1,3- and 1,4-bis-(isocyanato methylcyclohexane), and mixtures thereof. In addition, the polyisocyanate may include one or more kinds of any of the referenced isocyanate monomer units. The first component may preferably be selected from the group consisting of MDI, TDI, HID, and 1,3- and 1,4-bis-(isocyanatomethyl)cyclohexane.

The second component may be any alkylene oxide polyol, alkylene oxide monol, or combinations thereo; for example, the second component may preferably be a non-ionic hydrophilic alkylene oxide polyol, a non-ionic hydrophilic alkylene oxide monol, and combinations thereof. The alkylene oxide of the alkylene oxide polyol or the alkylene oxide monol may typically be ethylene, or propylene. The alkylene oxide of the alkylene oxide polyol or the alkylene oxide monol may preferably be ethylene. The alkylene oxide polyol or the alkylene oxide monol may be a homopolymer, or a copolymer. The alkylene oxide polyol or the alkylene oxide monol may further be a linear polymer, or a branched polymer. The alkylene oxide moieties of the non-ionic hydrophilic alkylene oxide polyol or non-ionic hydrophilic alkylene oxide monol may either be randomly distributed or block distributed. Such non-ionic hydrophilic alkylene oxide polyols include, but are not limited to, polyethylene oxide, polypropylene oxide, polybutylene oxide, polytetramethylene oxide, blends thereof, and combinations thereof. The second component may preferably be a non-ionic hydrophilic polyethylene oxide. The second component may further include non-ionic hydrophobic polyols including, but not limited to, polyethylene oxide, polypropylene oxide, polybutylene oxide, polytetramethylene oxide, aromatic or aliphatic polyester polyols, polycaprolactone polyols, acrylic polyols, blends thereof, and combinations thereof. The second component may comprise up to 90 percent by weight of the non-ionic hydrophilic alkylene oxide polyol or non-ionic hydrophilic alkylene oxide monol, based on the weight of the second component. All individual values and subranges from 0 to 90 percent by weight are included herein and disclosed herein; for example, the second component may comprise about 10 to 90 percent by weight of the non-ionic hydrophilic alkylene oxide polyol or the non-ionic hydrophilic alkylene oxide monol, based on the weight of the second component; or in the alternative, the second component may comprise at least 80 percent by weight of the non-ionic hydrophobic alkylene oxide polyol or the non-ionic hydrophobic alkylene oxide monol, based on the weight of the second component.

The non-ionic hydrophilic polyurethane prepolymer may comprise any amounts of either the first component or the second component. The non-ionic hydrophilic polyurethane prepolymer may comprise up to about 90 percent by weight of the first component, based on the weight of the non-ionic hydrophobic polyurethane prepolymer. All individual values and subranges from 0 to 90 percent by weight are included herein and disclosed herein; for example, the non-ionic hydrophilic polyurethane prepolymer may comprise up to about 50 percent by weight of the first component, based on the weight of the non-ionic hydrophilic polyurethane prepolymer; or in the alternative, the non-ionic hydrophilic polyurethane prepolymer may comprise up to about 20 percent by weight of the first component, based on the weight of the non-ionic hydrophilic polyurethane prepolymer. Furthermore, the non-ionic hydrophilic polyurethane prepolymer may comprise up to about 90 percent by weight of the second component, based on the weight of the non-ionic hydrophilic polyurethane prepolymer. All individual values and subranges from 0 to 90 percent by weight are included herein and disclosed herein; for example, the second component may comprise about 10 to 90 percent by weight of the non-ionic hydrophilic alkylene oxide polyol or the non-ionic hydrophilic alkylene oxide monol, based on the weight of the second component; or in the alternative, the second component may comprise at least 80 percent by weight of the non-ionic hydrophobic alkylene oxide polyol or the non-ionic hydrophobic alkylene oxide monol, based on the weight of the second component. The non-ionic hydrophilic polyurethane prepolymer may comprise up to about 10 percent by the combined weight of the additional components, based on the weight of the non-ionic hydrophilic polyurethane prepolymer. All individual values and subranges from 0 to 10 percent by weight are included herein and disclosed herein; for example, the non-ionic hydrophilic polyurethane prepolymer may comprise up to about 5 percent by the combined weight of the additional components, based on the weight of the non-ionic hydrophilic polyurethane prepolymer.

The aqueous non-ionic hydrophilic polyurethane dispersion may comprise any amount of the non-ionic hydrophilic polyurethane prepolymer; for example, the aqueous non-ionic hydrophilic polyurethane dispersion may comprise up to about 70 percent by weight of the non-ionic hydrophilic polyurethane prepolymer, based on weight of the aqueous non-ionic hydrophilic polyurethane dispersion. All individual values and subranges from 0 to 70 percent by weight are included herein and disclosed herein; for example, the aqueous non-ionic hydrophilic polyurethane dispersion may comprise up to about 30 percent by weight of the non-ionic hydrophilic polyurethane prepolymer, based on weight of the aqueous non-ionic hydrophilic polyurethane dispersion; or in the alternative, the aqueous non-ionic hydrophilic polyurethane dispersion may comprise up to about 20 percent by weight of the non-ionic hydrophilic polyurethane prepolymer, based on weight of the aqueous non-ionic hydrophilic polyurethane dispersion. For example, the aqueous non-ionic hydrophilic polyurethane dispersion may comprise up to about 10 percent by weight of the non-ionic hydrophilic polyurethane prepolymer, based on weight of the aqueous non-ionic hydrophilic polyurethane dispersion. Furthermore, the non-ionic hydrophilic polyurethane dispersion may comprise any amount of water; for example, the non-ionic hydrophilic polyurethane dispersion may comprise 30 to 90 percent by weight of water, based on weight of the aqueous non-ionic hydrophilic polyurethane dispersion. All individual values and subranges from 30 to 90 percent by weight are included herein and disclosed herein; for example, the non-ionic hydrophilic polyurethane dispersion may comprise 70 to 90 percent by weight of water, based on weight of the aqueous non-ionic hydrophilic polyurethane dispersion; or in the alternative, the aqueous non-ionic hydrophilic polyurethane dispersion may comprise 80 to 90 percent by weight of water, based on weight of the aqueous non-ionic hydrophilic polyurethane dispersion.

The aqueous non-ionic hydrophilic polyurethane dispersion may optionally include one or more surfactants. Such surfactants are typically included in the water phase. The surfactant may, for example, be anionic, non-ionic, cationic, zwitterionic, or a mixture of non-ionic with cationic, anionic or zwitterionic. Preferred surfactants are non-ionic, and anionic surfactants. The surfactant, which is not incorporated into the polymer backbone, is selected from the group consisting of metal or ammonium salts of sulfonates, phosphates and carboxylates. Suitable surfactants include alkali metal salts of fatty acids such as sodium stearate, sodium palmitate, potassium oleate, alkali metal salts of fatty acid sulfates such as sodium lauryl sulfate, the alkali metal salts of alklylbenzenesulfate and alkylbenzenesulfonate, and alkylnaphthalenesulfate and alkylnaphthalenesulfate, such as sodium dodecylbenzenesulfonate, sodium alkylnaphthalene-sulfonate; the alkali metal salts of dialkyl-sulfosuccinates; the alkali metal salts of sulfated alkylphenol ethoxylates such as sodium octylphenoxypolyethoxyethyl sulfate; the alkali metal salts of polyethoxyalcohol sulfates and the alkali metal salts of polyethoxyalkylphenol sulfates. More preferably, the anionic surfactant may be sodium dodecyl benzene sulfonate, sodium dodecyl sulfonate, sodium dodecyl diphenyl oxide disulfonate, sodium n-decyl diphenyl oxide disulfonate, isopropylamine dodecylbenzenesulfonate, or sodium hexyl diphenyl oxide disulfonate, and most preferably, the anionic surfactant may be sodium dodecyl benzene sulfonate. Non-ionic surfactants may, for example, be ethylene oxide adducts of phenols, such as nonyl phenol, and ethoxylated fatty acids, ethoxylated fatty acids ester, glycol ester, and combinations thereof. The aqueous non-ionic hydrophilic polyurethane dispersion may optionally comprise from 0 to about 6 percent by weight of a surfactant, based on the total weight of the aqueous non-ionic hydrophilic polyurethane dispersion. All individual values and subranges from 0 to 6 percent by weight are included herein and disclosed herein; for example, the aqueous non-ionic hydrophilic polyurethane dispersion may optionally comprise from 0.05 to about 5 percent by weight of a surfactant, based on the total weight of the aqueous non-ionic hydrophilic polyurethane dispersion. In general, it is desired to add a sufficient amount of surfactant to facilitate the production of an aqueous non-ionic hydrophilic dispersion having an average particle size in the range of 20 to 1000 nm, more preferably 40 to 150 nm, and a polydispersity in the range of 1.0 to 5.0, and more preferably 1.0 to 2.0. Surfactants, preferably externally added, play an important role in the formation and stabilization of emulsions, and dispersions. Generally, higher surfactant concentrations result in smaller diameter particles, but surfactant concentrations that are too high tend to deleteriously affect the properties of products. A person of ordinary skill in the art can readily determine the appropriate surfactant type and concentration for the particular process and end use.

Although water can be used as a chain-extending agent, the polyurethane dispersion of the instant invention may further include other chain-extending agents without incorporating any ionic properties into the polyurethane particles such as aliphatic, cycloaliphatic, aromatic polyamines, and alcohol amines for building of molecular weight. Therefore, the prepolymer may preferably be contacted with a chain-extending agent before substantial reaction takes place between water and the prepolymer. The chain-extending agents include, but are not limited to, hydrazine, ethylene diamine, hexamethylene diamine, aminated polyoxyalkyleneddiol, 1,3-1,4 bis(aminomethyl)cyclehexane, and isophoronediamine.

The aqueous non-ionic hydrophilic polyurethane dispersion according to instant invention may further include other optional additives, such as phase modifiers. Such phase modifiers may be included in the water during the preparation of the non-ionic hydrophilic polyurethane dispersion. Colloidal stability of the non-ionic hydrophilic polyurethane dispersion may be enhanced by including with the water from 0.5 to 8 weight percent of a protective colloid, such as poly(vinyl alcohol), or an anionic surfactant. Such phase modifiers are present typically in the amount of from 0.1 to 5 weight percent of the non-ionic hydrophilic polyurethane dispersion. The non-ionic hydrophilic polyurethane dispersion according to instant invention may further include rheology modifiers such as ammonium alginate and methyl cellulose which give desirable flow characteristics; fillers such as clays, carbon black and colloidal silica and talc to modify tensile, abrasion and tear properties; dyes and pigments; antidegradants; and softeners such as mineral oil to control modulus. Additionally, the non-ionic hydrophilic polyurethane dispersion may be blended with other emulsions, and dispersions including, but not limited to, polyolefin dispersions, epoxy dispersions, acrylic dispersions, styrene/butadiene dispersions, combinations thereof.

The non-ionic hydrophilic polyurethane dispersion according to instant invention may further include any other additive which is known to those of ordinary skill in the end-use to which the inventive polyurethane dispersions are applied can be used so long as their presence does not degrade the desired properties of the end-use product. Such additives can be incorporated into the dispersions in any way known to be useful including, but not limited to, inclusion in the prepolymer formulation and inclusion in the water used to make the dispersion. Other suitable additives include titanium dioxide, calcium carbonate, silicon oxide, defoamers, biocides, carbon particles.

In production, the aqueous non-ionic hydrophilic polyurethane dispersion of the instant invention is made by mixing the prepolymer with water, optionally in the presence of a surfactant, optionally other additives and/or phase modifiers, and/or optionally a chain-extending agent, at a temperature of from 10 to 90° C., to render the desired aqueous non-ionic hydrophilic polyurethane dispersion. An excess amount of water may be used to control the solid content.

The aqueous non-ionic hydrophilic polyurethane prepolymer may be prepared by a batch, or a continuous process. For example, in a continuous process, a stoichiometric excess of an aromatic or aliphatic polyisocyanate, and non-ionic hydrophilic ethylene oxide polyol or monol may be introduced in separate streams into a static or an active mixer, preferably in the absence of a catalyst, and at a temperature suitable for controlled reaction of the reagents, typically from 40° C. to 100° C. at atmospheric pressure. The reaction may be carried to substantial completion in a plug flow reactor to form the non-ionic hydrophilic polyurethane prepolymer. In alternative, for example, in a batch process, non-ionic hydrophilic ethylene oxide polyol or monol is introduced into a reactor. The temperature of the reactor is raised, for example to 70° C., while agitating the non-ionic hydrophilic ethylene oxide polyol or monol. Aromatic or aliphatic polyisocyanates are added to the reactor in the absence of any catalyst, and the temperature of the reactor is being raised, for example to 80° C. while agitation process continues for a certain period of time, for example four hours. In case a catalyst is present, the reaction conditions such as temperature or time required for the reaction to take place may be lowered.

The aqueous non-ionic hydrophilic polyurethane dispersions of the instant invention, preferably made as a high internal phase ratio (HIPR) emulsion, contain the reaction product of the non-ionic hydrophilic polyurethane prepolymer (as the dispersed phase) and water (as the continuous phase). When present, the chain-extending agent and/or surfactant appear in the continuous phase. The use of HIPR process renders certain advantages to non-ionic hydrophilic polyurethane dispersions (PUDs), most particularly the ability to produce solvent-free non-ionic hydrophilic polyurethane dispersions from highly reactive (for example aromatic isocyasnates) in the absence of any solvent. Furthermore, HIPR process does not require to use ionic species to impart dispersibility. Additionally, HIPR process allows the preparation of highly stabilized dispersions at high loadings of prepolymer formulations that are relatively hydrophobic and non-ionic, and are difficult to disperse in conventional batch processes.

Methods of preparing HIPR emulsions are known in the art. See, for example, U.S. Pat. No. 6,087,440 as well as U.S. Pat. No. 5,539,021. The dispersed phase of such emulsions exhibits close compact arrangement of spheres of generally equal radius and is characterized by a volume fraction as high as 0.99. The HIPR emulsion may be stabilized by the adsorption of surfactant from the continuous phase on the surface of the dispersed particulates.

For the purposes of this invention, the term “continuous phase liquid stream” is used to denote a flowing liquid in which colloidal polymer particles are dispersed. Similarly, the term “dispersed phase liquid stream” is used to denote a flowing liquid that becomes the dispersed phase. Additionally, the term “dilution phase liquid stream” is used to denote a flowing liquid in which colloidal polymer particles are further dispersed. For the purposes of this specification, the term “liquid” is used to mean a homogeneous solution that can be pumped through a conduit. The liquid may be neat (that is, a liquid at room temperature) as well as molten (that is, a liquid at a temperature above room temperature).

The aqueous non-ionic hydrophilic polyurethane dispersions of the instant invention are prepared by continuously merging a continuous phase liquid stream having a flow rate R₁ and a disperse phase liquid stream having a flow rate R₂; and mixing the merged streams at a mixing rate sufficient to form the HIPR emulsion. The continuous phase and disperse phase liquid streams are sufficiently immiscible with each other to be emulsifiable. Polydispersity (“PDI”) of emulsions defines the number of species per unit of the mixture. This continuous process facilitates the control of the PDI of the dispersions. This is an important tool to control solids content of the dispersions. For the purposes of this invention, the term “polydispersity” is the ratio of volume and number averages and is defined as:

$$P D I = \frac{{d}_{v}}{{d}_{n}} = \frac{{[ \frac{Σ {n}_{i} {d}_{i}^{3}}{Σ {n}_{i}} ]}^{1 / 3}}{[ \frac{Σ {n}_{i} {d}_{i}}{Σ {n}_{i}} ]}$$

wherein
number average particle size distribution

$${d}_{n} = \frac{Σ {n}_{i} {d}_{i}}{Σ {n}_{i}}$$

volume average particle size distribution

$${d}_{v} = {[ \frac{Σ {n}_{i} {d}_{i}^{3}}{Σ {n}_{i}} ]}^{1 / 3}$$

weight average particle size distribution

$${d}_{w} = \frac{Σ {n}_{i} {d}_{i}^{4}}{Σ {n}_{i} {d}_{i}^{3}}$$

surface average particle size distribution

$${d}_{s} = \frac{Σ {n}_{i} {d}_{i}^{3}}{Σ {n}_{i} {d}_{i}^{2}}$$

where dₙ, is the number average particle size, nᵢ is the number of particles of diameter dᵢ.

Low PDI is an indication of narrow particle size distribution, and ability to control particle formation in a dispersion by a polymerization process. It is further a function of the particle size of the polyurethane prepolymer dispersed in the water phase. Thus, the total solid content of the polyurethane dispersions of the invention can be controlled by the particle size and polydispersity index (PDI) of the polyurethane particles. A PDI of 1.0 is an indication of monodispersed polymeric particles. The polydispersity of the polyurethane particles in the invention typically ranges from 1.1 to 10.0, preferably 1.5 to 6, and more preferably 1.1 to 2.0.

The aqueous non-ionic hydrophilic polyurethane dispersions of the instant invention are formed by continuously merging, in the optional presence of an emulsifying and stabilizing effective amount of surfactant and/or chain extender agents, a continuous phase liquid stream containing water flowing at a rate R₁, together with a disperse phase liquid stream containing the polyurethane prepolymer flowing at a rate R₂ under reaction conditions sufficient to form a polyurethane dispersion wherein the ratio of R₂:R₁ may be in the range of 10:90 to 30:70. All individual values and subranges from 10:90 to 30:70 are included herein and disclosed herein; for example, 20:80. The aqueous non-ionic hydrophilic polyurethane dispersions may further be diluted. For example, the aqueous non-ionic hydrophilic polyurethane dispersions may be merged and mixed with a dilution phase liquid stream containing water and optionally chain extender agents.

Although it is possible to first dissolve the prepolymer in a solvent prior to forming the high internal phase ratio (HIPR) emulsion, it is preferred to prepare the aqueous non-ionic hydrophilic polyurethane dispersion of the instant invention in the substantial absence of a solvent, more preferably in the absence of a solvent. The inclusion of a solvent often adds an unnecessary expense to the manufacture of the end-use product as well as health and environmental concerns. In particular, solvent removal, when necessary to obtain acceptable physical properties of the product, is also an expensive as well as a time-consuming step.

The resulting aqueous non-ionic hydrophilic polyurethane dispersions have a particle size sufficient to make them stable. The aqueous non-ionic hydrophilic polyurethane dispersions of the present invention will have a particle size of from 20 to 1,000 nm. All individual values and subranges from 20 to 1,000 nm are included herein and disclosed herein; for example, from 40 to 1000 nm; or in the alternative, from 40 to 200 nm.

Once the aqueous non-ionic hydrophilic polyurethane dispersions reach their destination for end use, they may further be diluted with sufficient amounts of water to facilitate the control of the final solid content of the dispersion.

The aqueous non-ionic hydrophilic polyurethane dispersions of the present invention exhibit high shear stability sufficient to be pumped in pipes in production facilities and application fields, to be shipped over long distances at various temperatures and humidity, and to be formulated with other additives. The dispersions even at high solids and high viscosities remain stable and can be diluted to lower solids content and lower viscosities.

The aqueous non-ionic hydrophilic polyurethane dispersions of the present invention can be used in many different applications. For example, the aqueous non-ionic hydrophilic polyurethane dispersions of the present invention can be incorporated into non-woven materials, woven textiles, gauze, paper, films, foams, or their precursors, through coating, spraying, molding, extrusion, saturation, frothing or similar techniques to regulate moisture and vapor transmission, enhance fluid absorption and retention capacity, function as a barrier to gases and fluids, or move moisture away from the composite material's contact surface. The dispersion can also function to incorporate, encapsulate, bind and/or deliver various chemicals and compounds used to enhance the properties of the composite material in household and institutional cleaning, apparel, personal care, healthcare, dental care, laundry, filtration, fragrance delivery, footwear, and agricultural applications.

The aqueous non-ionic hydrophilic polyurethane dispersions of the present invention can also be utilized to produce a free film through casting, spraying, molding, injection, frothing or similar techniques with or without a variety of active chemicals or compounds that can be utilized in these same applications. Furthermore, these dispersions could be blended with other latexes and polymers. Further examples of end-use applications of the aqueous non-ionic hydrophilic polyurethane dispersions of the present invention include, but are not limited to, the following;
1) Wound dressings and first aid dressings with enhanced absorbency and/or incorporating various antiseptic, antimicrobial, antiviral, or antifungal and compounds or as an adhesive for adhering dressing to the skin;
2) Disposable or reusable washcloths containing soaps, surfactants, antimicrobial, antiviral, or other antiseptic compounds used to clean and/or sanitize human or animal skin;
3) Disposable or reusable wipes, towels, or foams containing active compounds used in personal care applications to cleanse, rehydrate or moisturize skin, reduce skin wrinkles, treat acne, eczema, rashes, insect bites or stings, or other skin disorders;
4) Disposable or reusable wipes, towels, or foams containing active compounds used to deliver sunscreen, sun block, fragrance, or insect repellant chemicals and compounds.
5) Disposable or reusable wipes, towels, foams, or sponge material containing chemicals and compounds used for household or institutional hard surface cleaning and sanitizing such as countertops, sinks, appliances, cutting surfaces, utensils, dishes, glassware, bathroom surfaces, furniture, or windows;
6) Disposable or reusable sheets containing chemicals and compounds used as softeners and static reducing agents in clothing or used to launder clothing;
7) Disposable or reusable toweling materials used in household, commercial, or institutional applications to control spills and absorb fluids;
8) Baby diapers, child training pants or adult diapers to optimize fluid absorption, fluid retention, or moisture management and/or to deliver chemicals and compounds to reduce skin chaffing, irritation, infection risk, or to reduce or mask malodor;
9) Disposable or reusable toweling material containing static dissipative chemicals and compounds for cleaning of electronic equipment, electronic equipment, computer screens and keyboards, or clean room and laboratory surface areas;
10) Disposable bed linen and underpads used on institutional, commercial, or household beds;
11) Disposable or reusable cosmetic applicator or cosmetic removal pads and devices;
12) Disposable or reusable lens cleaning tissues for eyewear;
13) Disposable or reusable apparel used by healthcare, dental care, EMS, hazardous material handling or abatement personnel;
14) Disposable or reusable healthcare drapes and packs;
15) Disposable surgical drapes;
16) Disposable or reusable footwear insoles, midsoles, or accessory products designed to be inserted in footwear to optimize comfort, control perspiration, and/or minimize malodor;
17) Disposable or reusable air or fluid filtration media;
18) Topically sprayed free films used in agricultural applications to function as a barrier to weed germination or growth; control erosion; deliver agricultural nutrients, pesticides, herbicides, growth stimulants, or mold inhibiting chemicals and compounds; deliver and entrap seed; and/or to absorb and retain water to enhance plant root development and growth;
19) Sub-surface injected material around tree and plant roots to enhance water retention, act as a thermal barrier, and/or deliver chemicals and compounds necessary to restore plant health, and/or enhance plant vigor;
20) Sub-surface injected material into soil to enhance water absorption and retention and/or deliver chemicals and compounds necessary to rejuvenate the soil, or optimize earthworm health and reproduction; and
21) Substrate laminating or skin contact adhesive, or adhesive component, used in medical, apparel, textile, industrial, construction, household and personal care applications.

From the foregoing, it will be observed that numerous variations and modifications may be effected without departing from the true spirit and scope of the novel concepts of the invention. The following non-limiting examples, and comparative demonstrations, bring out the more salient features of this invention.

### Test Methods

Test methods include the following:

Particle size and particle distribution was measured via Dynamic Light Scattering (Coulter LS 230).

Viscosities of the prepolymers were measured according using AR 2000 Rheometer (TA Instrument).

Isocyanate content (Percent NCO) was determined using a Meter Toledo DL58.

### EXAMPLES

The following examples illustrate the present invention but are not intended to limit the scope of the invention.

Aqueous non-ionic hydrophilic polyurethane dispersions, as shown in Examples 1-3 of Table I, were prepared according to instant invention.

Non-woven substrates impregnated with the aqueous non-ionic hydrophilic polyurethane dispersions, as shown in Examples A-D of Table II, were prepared according to instant invention. Furthermore, a non-woven substrate impregnated with a control polyurethane dispersion, as shown in the comparative Example E, was also prepared under the same conditions as Examples A-D.

Examples A-D and the comparative Example E were tested for their water absorption capabilities under the same conditions, and the results are shown in Table III. The dried impregnated samples were weighted and then submerged in distilled water at 25° C. for 30 seconds. Once removed from water, excess water was removed from the surface by hand and the samples were reweighed, and the results are shown in Table III.

TABLE I

| Content | Example 1 | Example 2 | Example 3 |
|---|---|---|---|
| Pluronics 10R5 | 22.4 | 36.9 | 21.9 |
| Pluronics V- | 52.2 | 36.9 | 51.1 |
| 4701 | | | |
| MDI, I-125M | 23.9 | 24.7 | 25.6 |
| Tegomer D3403 | 1.5 | 1.5 | 1.5 |
| Percent NCO | 5.39 | 5.34 | 5.35 |
| Results | Clear | Clear | Clear |
| Viscosity @ 25 | 8871 | 9260 | 9548 |
| ° C. | | | |
| Viscosity @ 40 | 3323 | 3406 | 3446 |
| ° C. | | | |
| Particle Size | ~60 | <40 | <40 |
| (Dv, nm) | | | |

TABLE II

| | Polyurethane | Initial | Final | |
|---|---|---|---|---|
| Example | Dispersion No. | Weight of | Weight of | Polymer Pick- |
| No. | (Table I) | Substrate (g) | Substrate (g) | Up (g/m²) |
| A | 3 | 1.55 | 2.56 | 18.8 |
| B | 3 | 1.66 | 2.09 | 7.5 |
| C | 2 | 1.51 | 2.3 | 15.1 |
| D | 2 | 1.48 | 1.84 | 7.0 |
| E | Control | — | — | 0 |

TABLE III

| | Dry | Wet | Sample | Water | Water |
|---|---|---|---|---|---|
| Example | Weight | Weight | Area | Absorption | Absorption |
| No. | (g) | (g) | (m²) | (wt percent) | (g/m²) |
| A | 0.867 | 2.613 | 0.018 | 201 | 96 |
| B | 0.729 | 1.595 | 0.020 | 319 | 43 |
| C | 0.766 | 2.301 | 0.017 | 200 | 88 |
| D | 0.583 | 1.43 | 0.016 | 145 | 52 |
| E | 0.501 | 0.66 | 0.017 | 32 | 9 |

We claim:

1. An aqueous non-ionic hydrophilic polyurethane dispersion comprising the reaction product of:
a non-ionic hydrophilic prepolymer comprising the reaction product of:
a first component, wherein said first component being selected from the group consisting of an aromatic polyisocyanate, an aliphatic polyisocyanate, and combinations thereof; and
a second component, wherein said second component being a hydrophilic alkylene oxide polyol, a non-ionic hydrophilic alkylene oxide monol, or combinations thereof;
wherein said polyurethane prepolymer comprising at least 80 percent by weight of the second component, based on the weight of said polyurethane prepolymer;
water;
optionally an external surfactant; and
optionally a chain extending reagent.

2. The non-ionic hydrophilic aqueous polyurethane dispersion according to claim 1, wherein said second component further including a non-ionic hydrophobic alkylene oxide polyol or a non-ionic hydrophobic alkylene oxide monol.

3. The non-ionic hydrophilic aqueous polyurethane dispersion according to claim 1, wherein said hydrophilic alkylene oxide polyol or said hydrophilic alkylene oxide monol being a homopolymer, or a copolymer.

4. The non-ionic hydrophilic aqueous polyurethane dispersion according to claim 3, wherein said copolymer being a block copolymer or a random copolymer.

5. The non-ionic hydrophilic aqueous polyurethane dispersion according to claim 1, wherein said hydrophilic alkylene oxide polyol being polyethylene oxide.

6. The non-ionic hydrophilic aqueous polyurethane dispersion according to claim 1, wherein said aromatic polyisocyanate being selected from the group consisting of MDI, TDI, and PMDI.

7. The non-ionic hydrophilic aqueous polyurethane dispersion according to claim 1, wherein said aliphatic polyisocyanate being selected from the group consisting of HDI, IPDI, and H₁₂MDI.

8. The non-ionic hydrophilic aqueous polyurethane dispersion according to claim 1, wherein said surfactant being an external surfactant.

9. A continuous process for producing a non-ionic hydrophilic aqueous polyurethane dispersion comprising the steps of:
providing disperse phase liquid stream having a flow rate R₂, wherein said disperse phase liquid stream containing a non-ionic hydrophilic polyurethane prepolymer comprising the reaction product of;
a first component, wherein said first component being an aromatic polyisocyanate, aliphatic polyisocyanate, or combinations thereof; and
a second component, wherein said second component being a non-ionic hydrophilic alkylene oxide polyol, a non-ionic hydrophilic alkylene oxide monol, or combinations thereof;
wherein said polyurethane prepolymer comprising at least 80 percent by weight of the second component, based on the weight of said polyurethane prepolymer;
water;
providing a continuous phase liquid stream having a flow rate R₁, wherein said continuous phase liquid stream comprising water and optionally a surfactant;
continuously merging said disperse phase liquid stream and said continuous phase liquid stream into a high-shear disperser, wherein R₂:R₁ being in the range of 10:90 to 30:70;
emulsifying said non-ionic hydrophilic polyurethane prepolymer in said water via a high-shear disperser; and
thereby producing said non-ionic hydrophilic aqueous polyurethane dispersion.

10. The continuous process for producing an aqueous polyurethane dispersion according to claim 9, wherein said process further including the steps of:
providing a dilution phase liquid stream; wherein said dilution phase liquid stream comprising water and optionally a chain extender agent; and
admixing said dilution phase liquid stream with said non-ionic hydrophilic aqueous polyurethane dispersion;
thereby diluting said non-ionic hydrophilic aqueous polyurethane dispersion.

11. The continuous process for producing an aqueous polyurethane dispersion according to claim 9, wherein said hydrophilic alkylene oxide polyol being a homopolymer, or a copolymer.

12. The continuous process for producing an aqueous polyurethane dispersion according to claim 9, wherein said hydrophilic alkylene oxide polyol being polyethylene oxide.

13. The continuous process for producing an aqueous polyurethane dispersion according to claim 9, wherein said R₁:R₂ ratio being at least 20:80.

14. The continuous process for producing an aqueous polyurethane dispersion according to claim 9, wherein said R₂:R₁ ratio being at least 10:90.

15. The continuous process for producing an aqueous polyurethane dispersion according to claim 9, wherein said aliphatic polyisocyanate being selected from the group consisting of HDI, IPDI, and H₁₂MDI.

16. The continuous process for producing an aqueous polyurethane dispersion according to claim 9, wherein said aromatic polyisocyanate being selected from the group consisting of MDI, TDI, and PMDI.

17. The continuous process for producing an aqueous polyurethane dispersion according to claim 9, wherein said surfactant being san external surfactant.

18. A polyurethane polymer coated substrate prepared by a process comprising the steps of:
preparing a non-ionic hydrophilic aqueous polyurethane dispersion according to claim 9;
applying said non-ionic hydrophilic aqueous polyurethane dispersion to a substrate;
dehydrating said non-ionic hydrophilic aqueous polyurethane dispersion; and
thereby forming said polyurethane coated substrate.

19. A polyurethane polymer impregnated substrate prepared by a process comprising the steps of:
preparing a non-ionic hydrophilic aqueous polyurethane dispersion according to claim 9;
impregnating said substrate with said non-ionic hydrophilic aqueous polyurethane dispersion;
dehydrating said non-ionic hydrophilic aqueous polyurethane dispersion; and
thereby forming said polyurethane impregnated substrate.
